(19) United States
(12) Patent Application Publication
(10) Pub. No.: US 2021/0271207 A1
(43) Pub. Date: Sep. 2, 2021

(54) ALARM CLOCK WITH KEYPAD

(71) Applicant: PURVESH THAKKER, ESCONDIDO, CA (US)

(72) Inventor: PURVESH THAKKER, ESCONDIDO, CA (US)

(21) Appl. No.: 16/877,587

(22) Filed: May 19, 2020

Related U.S. Application Data
(60) Provisional application No. 62/984,069, filed on Mar. 2, 2020.

(51) Int. Cl. G04G 13/02; G06F 3/0489

(52) U.S. Cl. CPC G04G 13/021; G06F 3/0489

(57) ABSTRACT

The alarm clock with keypad comprises a housing and an alarm clock. The alarm clock is an electric circuit. The housing contains the alarm clock. The alarm clock: a) displays the time; b) generates an alarm at a previously specified time; and, c) discontinues the generated alarm when the generated sequence of alphanumeric characters are entered into the alarm clock with keypad.

### CROSS REFERENCES TO RELATED APPLICATIONS

This non-provisional application claims priority under 35 USC 119(e) to United States provisional application U.S. 62/984,069 filed on Mar. 2, 2020, by the inventor: Purvesh Thakker of Marlborough, Mass.

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of horology including input devices integrated into timepieces, more specifically, an input device adapted for use in measuring physiological (psychological) data. (G04G21/025)

### Background of the Invention

A habit is a powerful form of psychological conditioning. The habit refers to the behavior of an individual that is performed without the individual thinking about the behavior and, in many instances, without the individual realizing that the behavior has been performed. The countdown refers to an individual speaking out loud a series of numbers in descending order. For example, the numerical series 5, 4, 3, 2, 1 would form a countdown when spoken out loud. The countdown is also a powerful psychological tool in our society. The hearing or speaking a countdown by an individual generates a sense of urgency within the individual. The countdown also generates other psychological effects including, but not limited to: a) providing an individual hearing or speaking a countdown with a sense of control over their time; and, b) increasing the focus of an individual hearing or speaking a countdown on the task at hand. The psychological effects of the countdown can be used to develop in an individual a desirable habit.

Many individuals have difficulty in taking action when waking up in the morning. By difficulty is meant that an individual does not wake up immediately prepared to take productive actions. Many individuals consider this difficulty an undesirable behavioral trait. Clearly, the ability to develop a habit that helps an individual wake up immediately prepared to take productive actions would be of benefit to these individuals.

### SUMMARY OF INVENTION

The alarm clock with keypad is a device that is adapted for use with an individual. The alarm clock with keypad requires of the individual a regularly scheduled repetitive action intended to trigger a habit. The alarm clock with keypad generates an alarm at a predetermined time. The generated alarm is selected from the group consisting of: a) an audible alarm; b) a visual alarm; c) a tactile alarm; and, d) any combination of two or more alarms selected from the preceding (a), (b), and (c). Once initiated, the generated alarm is discontinued by entering a generated sequence of alphanumeric characters into the alarm clock with keypad. The applicant anticipates that the generated sequence of alphanumeric characters will be a countdown code. However, those skilled in the electrical arts will recognize that any generated sequence of alphanumeric characters can be used do disable the generated alarm.

The alarm clock with keypad comprises a housing and an alarm clock. The alarm clock is an electric circuit. The housing contains the alarm clock. The alarm clock: a) displays the time; b) generates an alarm at a previously specified time; and, c) discontinues the generated alarm when the generated sequence of alphanumeric characters are entered into the alarm clock with keypad.

These together with additional objects, features and advantages of the alarm clock with keypad will be readily apparent to those of ordinary skill in the art upon reading the following detailed description of the presently preferred, but nonetheless illustrative, embodiments when taken in conjunction with the accompanying drawings.

In this respect, before explaining the current embodiments of the alarm clock with keypad in detail, it is to be understood that the alarm clock with keypad is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the alarm clock with keypad.

It is therefore important that the claims be regarded as including such equivalent construction insofar as they do not depart from the spirit and scope of the alarm clock with keypad. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a side view of an embodiment of the disclosure.

FIG. 3 is a front view of an embodiment of the disclosure.

FIG. 4 is a top view of an embodiment of the disclosure.

FIG. 5 is a block diagram of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

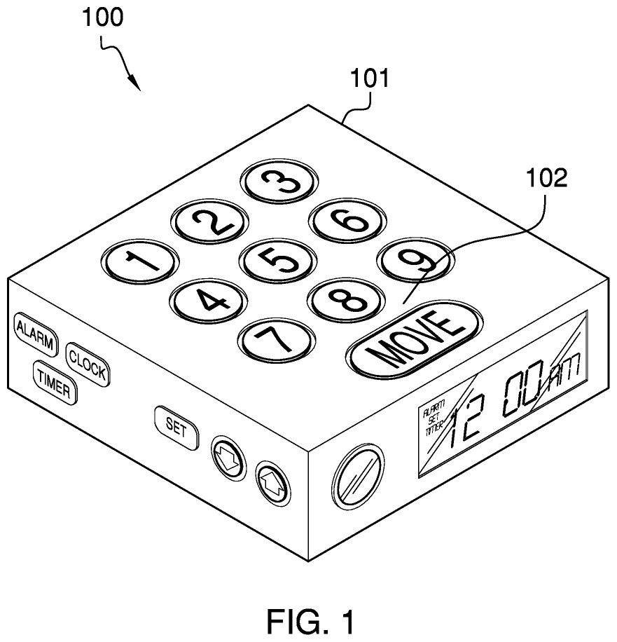

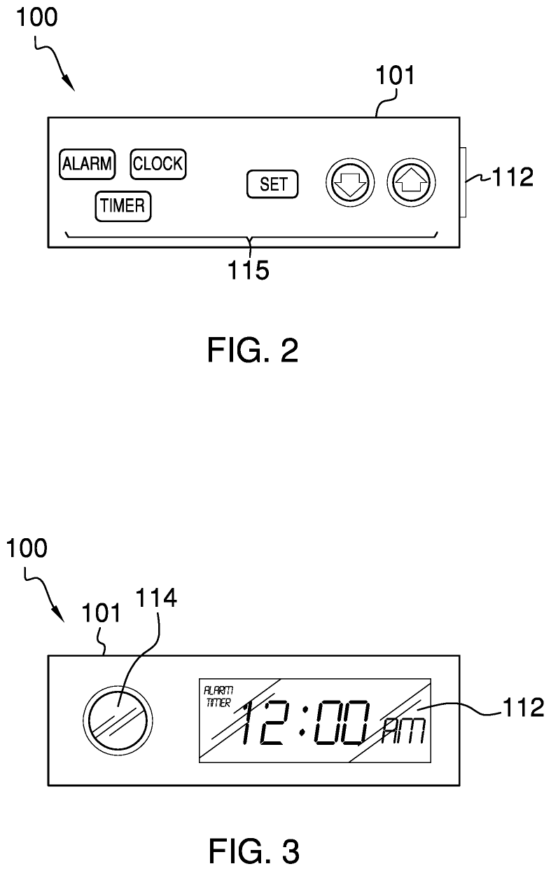

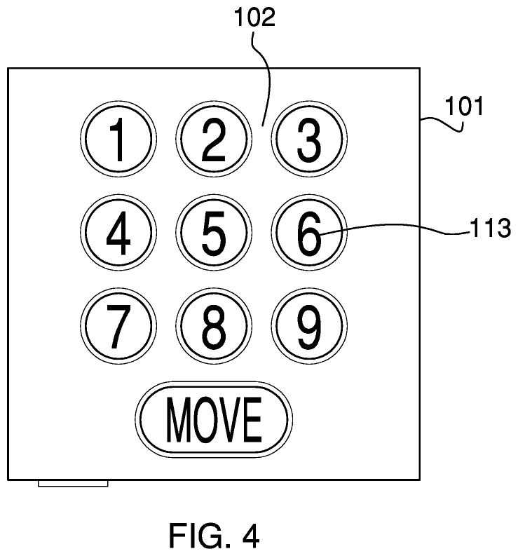

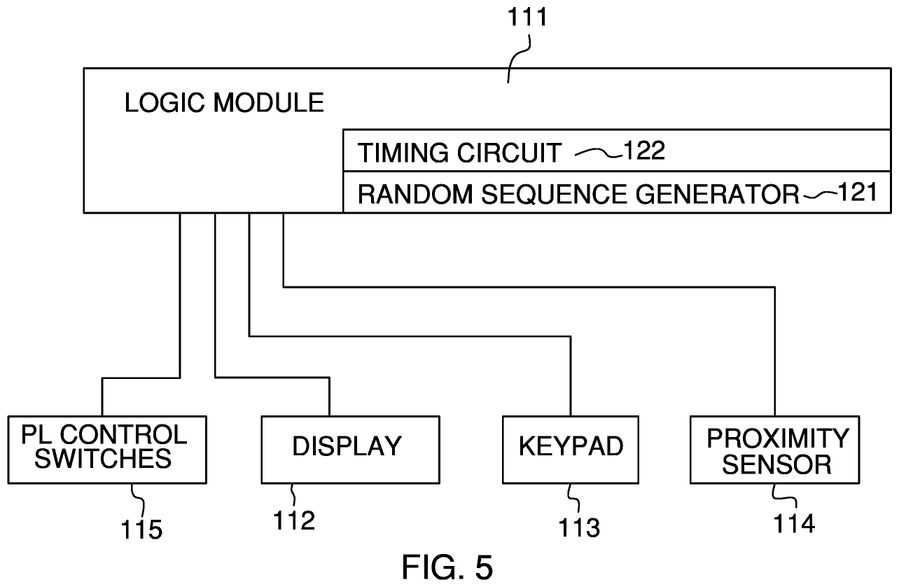

Detailed reference will now be made to one or more potential embodiments of the disclosure, which are illustrated in FIGS. 1 through 5.

Detailed reference will now be made to one or more potential embodiments of the disclosure, which are illustrated in FIGS. 1 through 5.

The alarm clock with keypad 100 (hereinafter invention) is a device that is adapted for use with an individual. The invention 100 requires of the individual a regularly scheduled repetitive action intended to trigger a habit. The invention 100 generates an alarm at a predetermined time. The generated alarm is selected from the group consisting of: a) an audible alarm; b) a visual alarm; c) a tactile alarm; and, d) any combination of two or more alarms selected from the preceding (a), (b), and (c). Once initiated, the generated alarm is discontinued by entering a generated sequence of alphanumeric characters into the invention 100. The applicant anticipates that the generated sequence of alphanumeric characters will be a countdown code, however, those skilled in the electrical arts will recognize that any generated sequence of alphanumeric characters can be used do disable the generated alarm.

The invention 100 comprises a housing 101 and an alarm clock 102. The alarm clock 102 is an electric circuit. The housing 101 contains the alarm clock 102. The alarm clock 102: a) displays the time; b) generates an alarm at a previously specified time; and, c) discontinues the generated alarm when the generated sequence of alphanumeric characters are entered into the invention 100.

The housing 101 is a rigid casing. The housing 101 contains the alarm clock 102. The housing 101 is formed with all apertures and form factors necessary to allow the housing 101 to accommodate the use and operation of the alarm clock 102. Methods to form a housing 101 suitable for the purposes described in this disclosure are well-known and documented in the mechanical arts.

The alarm clock 102 is an electric circuit. The alarm clock 102 is a time keeping device. The alarm clock 102 generates an alarm at a previously specified time. The alarm clock 102 is defined elsewhere in this disclosure.

The alarm generated by the alarm clock 102 is disabled by entering a generated sequence of alphanumeric characters. The generated sequence of alphanumeric characters is displayed by the alarm clock 102. The generated sequence of alphanumeric characters is entered as it is displayed into the alarm clock 102. Once the generated sequence of alphanumeric characters is properly entered into the alarm clock 102, the alarm generated by the alarm clock 102 is disabled by the alarm clock 102. The alarm clock 102 has the ability to generate the generated sequence of alphanumeric characters as a randomly generated sequence of alphanumeric characters. In the first potential embodiment of the disclosure, the generated sequence of alphanumeric characters generated by the alarm clock 102 is a countdown sequence. The countdown sequence is chosen for the psychological benefits described in the Background section of this disclosure.

The alarm clock 102 comprises a logic module 111, a display 112, a keyboard 113, a proximity sensor 114, and a plurality of control switches 115. The logic module 111, the display 112, the keyboard 113, the proximity sensor 114, and the plurality of control switches 115 are electrically interconnected.

The logic module 111 is a programmable electronic device. The logic module 111 controls the operation of the alarm clock 102. The logic module 111 further comprises a random sequence generator 121 and a timing circuit 122.

The random sequence generator 121 is an electric circuit that provides a functionality that is provisioned with the logic module 111. The random sequence generator 121 generates a sequence of random numbers that the logic module 111 can use to: a) generate a randomly generated sequence of alphanumeric characters used as the generated sequence of alphanumeric characters; and, b) generate a randomly generated sequence of alphanumeric characters used to generate the initial number of a countdown sequence.

The timing circuit 122 is an electric circuit that is provisioned with the logic module 111. The logic module 111 uses the timing circuit 122 to measure the passage of time. The timing circuit 122 is defined elsewhere in this disclosure.

The display 112 is an electric device. The display 112 is defined elsewhere in this disclosure. The display 112 visibly displays alphanumeric text used by an individual to interface with the housing 101. The logic module 111 controls the operation of the display 112 and the alphanumeric content displayed on the display 112. The display 112 forms the portion of the interface to the logic module 111 that transmits operating data to the user. The display 112 displays to the user the generated sequence of alphanumeric characters that needs to be entered through the keyboard 113 to disable the alarm generated by the alarm clock 102.

The keyboard 113 is an electric device. The keyboard 113 is defined elsewhere in this disclosure. The logic module 111 controls the operation of the keyboard 113. The keyboard 113 forms the portion of the interface to the logic module 111 that transmits operating data from the user to the logic module 111. The keyboard 113 is the device the user uses to enter the generated sequence of alphanumeric characters.

The proximity sensor 114 is an electric sensor. The logic module 111 monitors the operation of the proximity sensor 114. The proximity sensor 114 detects the presence of a user near the alarm clock 102 to ensure that the user is an active participant during the entry of the generated sequence of alphanumeric characters. The proximity sensor 114 detects the presence of a user near the keyboard 113 as the generated sequence of alphanumeric characters is entered into the keyboard 113. The logic module 111 does not disable the alarm generated by the alarm clock 102 unless the proximity sensor 114 detects the presence of an individual.

Each of the plurality of control switches 115 is an electric switch. Each of the plurality of control switches 115 is an interface into the logic module 111. The logic module 111 monitors the operation of each of the plurality of control switches 115. The plurality of control switches 115 are used: a) to set the time on the alarm clock 102; b) to set the time the alarm generated by the alarm clock 102 is initiated; and, c) to perform any manual operations required to maintain the proper operation of the alarm clock 102.

The following definitions were used in this disclosure:

Alarm: As used in this disclosure, an alarm refers to a signal used to indicate the occurrence of an event.

Alarm Clock: As used in this disclosure, an alarm clock refers to a clock that further generates an alarm at a previously specified time. The alarm clock is commonly used to waken an individual from sleep.

Clock: As used in this disclosure, a clock is an instrument that measures duration. Clocks are often synchronized to a reference “time” that allows for communities to coordinate the scheduling of activities. Within this disclosure, a watch is considered to be a clock.

Countdown: As used in this disclosure, a countdown refers to the announcement, display, or presentation of numerical information in descending order.

Display: As used in this disclosure, a display is a surface upon which is presented an image, potentially including, but not limited to, graphic images and text, that is interpretable by an individual viewing the projected image in a meaningful manner. A display device refers to an electrical device used to present these images.

Form Factor: As used in this disclosure, the term form factor refers to the size and shape of an object.

Habit: As used in this disclosure, a habit is a form of psychological conditioning. A habit refers to a behavior or pattern of behaviors that have been performed so regularly that an individual will exhibit the behavior or pattern of behaviors without consciously think about or realizing that the behavior or pattern of behaviors have been performed. A “good” habit refers to a habit that the individual finds desirable. A bad habit refers to a habit that the individual finds undesirable.

Housing: As used in this disclosure, a housing is a rigid structure that encloses and protects one or more devices.

Keyboard: As used in this disclosure, a keyboard is a panel that further comprises a plurality of buttons that are commonly referred to as keys. The keyboard is commonly used to operate devices including, but not limited to, logical devices and musical instruments.

Logic Module: As used in this disclosure, a logic module is a readily and commercially available electrical device that accepts digital and analog inputs, processes the digital and analog inputs according to previously specified logical processes and provides the results of these previously specified logical processes as digital or analog outputs. The disclosure allows, but does not assume, that the logic module is programmable.

Maintained Switch: A used in this disclosure, a maintained switch is a switch that maintains the position that was set in the most recent switch actuation. A maintained switch works in an opposite manner to a momentary switch.

Maintenance: As used in this disclosure, maintenance refers to activities intended to reverse the reduction in the operating effectiveness of a device that occurs through the normal and intended use of the device.

Momentary Switch: As used in this disclosure, a momentary switch is a biased switch in the sense that the momentary switch has a baseline position that only changes when the momentary switch is actuated (for example when a pushbutton switch is pushed or a relay coil is energized). The momentary switch then returns to the baseline position once the actuation is completed. This baseline position is called the “normal” position. For example, a “normally open” momentary switch interrupts (open) the electric circuit in the baseline position and completes (closes) the circuit when the momentary switch is activated. Similarly, a “normally closed” momentary switch will complete (close) an electric circuit in the baseline position and interrupt (open) the circuit when the momentary switch is activated.

Motion Sensor: As used in this disclosure, a motion sensor refers to a commercially available sensor that generates an electrical signal should the motion sensor detect movement within its field of view.

Proximity Sensor: As used in this disclosure, a proximity sensor is an electrical device that senses the entry or presence of an object within a previously determined field of view.

Random: As used in this disclosure, random is an adjective that refers to an object or result that is selected using an unpredictable selection process. By unpredictable is meant that the outcome of the selection process cannot be determined before the implementation of the selection process. In this disclosure, pseudo-random refers to the use of a selection process that uses an algorithm that generates a series of outcomes that appear random but is predictable given adequate information to reproduce the series.

Sensor: As used in this disclosure, a sensor is a device that receives and responds in a predetermined way to a signal or stimulus. As further used in this disclosure, a threshold sensor is a sensor that generates a signal that indicates whether the signal or stimulus is above or below a given threshold for the signal or stimulus.

Switch: As used in this disclosure, a switch is an electrical device that starts and stops the flow of electricity through an electric circuit by completing or interrupting an electric circuit. The act of completing or breaking the electrical circuit is called actuation. Completing or interrupting an electric circuit with a switch is often referred to as closing or opening a switch respectively. Completing or interrupting an electric circuit is also often referred to as making or breaking the circuit respectively.

Timing Circuit: As used in this disclosure, a timing circuit refers to an electrical network of interconnected electrical elements, potentially including but not limited to, resistors, capacitors, diodes, transistors, and integrated circuit devices. The purpose of the timing circuit is to generate an electrical control signal after a predetermined amount of time. In common usage, a timing circuit is also referred to as timing circuitry. The “555” timing circuit is a well-known, documented, and commercially available timing circuit.

Timing Device: As used in this disclosure, a timing device is an automatic mechanism for activating or deactivating a device at a specific time or after a specific period of time. This disclosure assumes that the logic module is provisioned with a timing circuit that can be used as a timing device. A timing device that activates an audible alarm is often referred to as a timer.

With respect to the above description, it is to be realized that the optimum dimensional relationship for the various components of the invention described above and in FIGS. 1 through 5 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. An alarm clock with keypad comprising
a housing and an alarm clock;
wherein the alarm clock is an electric circuit;
wherein the housing contains the alarm clock;
wherein the alarm clock with keypad triggers a habit;
wherein the alarm clock with keypad generates an alarm at a predetermined time;
wherein the alarm generated by the alarm clock is disabled by entering a generated sequence of alphanumeric characters.

2. The alarm clock with keypad according to claim 1 wherein the housing is a rigid casing;

3. The alarm clock with keypad alarm clock according to claim 2
wherein the alarm clock is a time keeping device;
wherein the alarm clock generates an alarm at a previously specified time.

4. The alarm clock with keypad alarm clock according to claim 3
wherein the generated sequence of alphanumeric characters is displayed by the alarm clock;
wherein the generated sequence of alphanumeric characters is entered as it is displayed into the alarm clock.

5. The alarm clock with keypad alarm clock according to claim 4 wherein after the generated sequence of alphanumeric characters is properly entered into the alarm clock, the alarm generated by the alarm clock is disabled by the alarm clock.

6. The alarm clock with keypad alarm clock according to claim 5 wherein the alarm clock generates the generated sequence of alphanumeric characters as a randomly generated sequence of alphanumeric characters.

7. The alarm clock with keypad alarm clock according to claim 6
wherein the alarm clock comprises a logic module, a display, a keyboard, a proximity sensor, and a plurality of control switches;
wherein the logic module, the display, the keyboard, the proximity sensor, and the plurality of control switches are electrically interconnected.

8. The alarm clock with keypad alarm clock according to claim 7
wherein the logic module is a programmable electronic device;
wherein the logic module controls the operation of the alarm clock.

9. The alarm clock with keypad alarm clock according to claim 8
wherein the logic module further comprises a random sequence generator;
wherein the random sequence generator is an electric circuit that provides a functionality that is provisioned with the logic module;
wherein the random sequence generator generates a sequence of random numbers that the logic module uses to generate a randomly generated sequence of alphanumeric characters used as the generated sequence of alphanumeric characters.

10. The alarm clock with keypad alarm clock according to claim 9
wherein the logic module further comprises a timing circuit;
wherein the timing circuit is an electric circuit that is provisioned with the logic module;
wherein the logic module uses the timing circuit to measure the passage of time.

11. The alarm clock with keypad alarm clock according to claim 10
wherein the display is an electric device;
wherein the display visibly displays alphanumeric text used by an individual to interface with the housing;
wherein the logic module controls the operation of the display and the alphanumeric content displayed on the display;
wherein the display displays the generated sequence of alphanumeric characters that needs to be entered through the keyboard to disable the alarm generated by the alarm clock.

12. The alarm clock with keypad alarm clock according to claim 11
wherein the keyboard is an electric device;
wherein the logic module controls the operation of the keyboard;
wherein the keyboard is the device used to enter the generated sequence of alphanumeric characters.

13. The alarm clock with keypad alarm clock according to claim 12
wherein the proximity sensor is an electric sensor;
wherein the logic module monitors the operation of the proximity sensor;
wherein the proximity sensor is a motion sensor that detects the presence of a user near the keyboard as the generated sequence of alphanumeric characters is entered into the keyboard;
wherein the logic module does not disable the alarm generated by the alarm clock unless the proximity sensor detects the presence of an individual.

14. The alarm clock with keypad alarm clock according to claim 5 wherein the generated sequence of alphanumeric characters generated by the alarm clock is a countdown sequence.

15. The alarm clock with keypad alarm clock according to claim 14
wherein the alarm clock comprises a logic module, a display, a keyboard, a proximity sensor, and a plurality of control switches;
wherein the logic module, the display, the keyboard, the proximity sensor, and the plurality of control switches are electrically interconnected.

16. The alarm clock with keypad alarm clock according to claim 15
wherein the logic module is a programmable electronic device;
wherein the logic module controls the operation of the alarm clock.

17. The alarm clock with keypad alarm clock according to claim 16
wherein the logic module further comprises a random sequence generator;
wherein the random sequence generator is an electric circuit that provides a functionality that is provisioned with the logic module;
wherein the random sequence generator generates a sequence of random numbers that the logic module uses to generate a randomly generated sequence of alphanumeric characters used as the generated sequence of alphanumeric characters;
wherein the logic module further comprises a timing circuit;
wherein the timing circuit is an electric circuit that is provisioned with the logic module;
wherein the logic module uses the timing circuit to measure the passage of time.

18. The alarm clock with keypad alarm clock according to claim 17
wherein the display is an electric device;
wherein the display visibly displays alphanumeric text used by an individual to interface with the housing;
wherein the logic module controls the operation of the display and the alphanumeric content displayed on the display;
wherein the display displays the generated sequence of alphanumeric characters that needs to be entered through the keyboard to disable the alarm generated by the alarm clock.

19. The alarm clock with keypad alarm clock according to claim 18
wherein the keyboard is an electric device;
wherein the logic module controls the operation of the keyboard;
wherein the keyboard is the device used to enter the generated sequence of alphanumeric characters.

20. The alarm clock with keypad alarm clock according to claim 19
wherein the proximity sensor is an electric sensor;
wherein the logic module monitors the operation of the proximity sensor;
wherein the proximity sensor is a motion sensor that detects the presence of a user near the keyboard as the generated sequence of alphanumeric characters is entered into the keyboard;
wherein the logic module does not disable the alarm generated by the alarm clock unless the proximity sensor detects the presence of an individual.
